(19) United States
(12) Patent Application Publication
(10) Pub. No.: US 2025/0238855 A1
(43) Pub. Date: Jul. 24, 2025

(54) PRODUCT LABEL PLATFORM

(71) Applicant: Samuel David Raoof, Encino, CA (US)

(72) Inventor: Samuel David Raoof, Encino, CA (US)

(21) Appl. No.: 18/419,462

(22) Filed: Jan. 22, 2024

(51) Int. Cl. G06Q 30/0601; G06F 16/9035

(52) U.S. Cl. CPC G06Q 30/0643; G06F 16/9035; G06Q 30/0625

(57) ABSTRACT

A method includes displaying multiple products. The method also includes selecting a product from the multiple products in response to obtaining an input. The method also includes displaying a label associated with the product. The label includes at least a first section and a second section. The method further includes automatically populating first data into the first section and second data into the second section. The first data is associated with the product. In response to obtaining a first user input directed to the first data, the method includes restricting modification of the first data. In response to obtaining a second user input directed to the second data, the method includes updating the second data in view of the second user input to generate a revised label.

### TECHNICAL FIELD

This disclosure generally relates to generating product labels, and more specifically, to systems and methods for creating products labels and associated materials using a platform that may include or provide a user interface.

### BACKGROUND

Unless otherwise indicated herein, the materials described herein are not prior art to the claims in the present application and are not admitted to be prior art by inclusion in this section.

Designing and/or customizing labels for products (product labels) often includes multiple back and forth communications between design members, marketing members, and/or other participants associated with the product. In some instances, multiple iterations of the product labels may be generated and/or revised, all of which may increase an amount of time to obtain a final version of the product label. Further, some product labels may be constrained by legal and/or regulatory requirements that may further complicate the process of obtaining a final version of a product label.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include displaying multiple products. The method may also include selecting a product from the multiple products in response to obtaining an input. The method may also include displaying a label that may be associated with the product. The label includes at least a first section and a second section. The method may further include automatically populating first data into the first section and second data into the second section. The first data may be associated with the product. In response to obtaining a first user input directed to the first data, the method may include restricting modification of the first data. In response to obtaining a second user input directed to the second data, the method may include updating the second data in view of the second user input to generate a revised label.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for creating and modifying a product label and associated materials;

FIG. 2 illustrates a block diagram of an example product label;

FIG. 3A illustrates an example embodiment of a product label of FIG. 2;

FIG. 3B illustrates the product label of FIG. 3A applied to an example product;

FIG. 4 illustrates an example user interface which may be used to generate a product label and associated materials;

FIG. 5A illustrates an example user interface which may be used to generate a product label and associated materials;

FIG. 5B illustrates an example user interface which may be used to generate a product label and associated materials;

FIG. 6A illustrates an example user interface which may be used to design a product label and associated materials;

FIG. 6B illustrates an example user interface which may be used to design a product label and associated materials;

FIG. 7 illustrates an example user interface which may be used to generate a product label and associated materials;

FIG. 8 illustrates an example user interface that may be used to generate a product label and associated materials;

FIG. 9 illustrates a flowchart of an example method of generating a product label; and

FIG. 10 illustrates an example computing device.

### DETAILED DESCRIPTION

Designing and generating custom labels for products may include multiple time-consuming processes in getting to a final product. The user (e.g., a person looking to generate a product label) may have an idea of what is desired, but creating the product label often includes many revisions with designers or other stakeholders that may delay the process of generating the product label. In some instances, a product label may be subject to regulations and/or legal requirements that may be associated with the product that the product label is being generated for. Compliance with the regulations and/or legal requirements may add additional steps to the process of generating a product label. For example, a design by a designer may be approved by the user, but the design may fail to comply with regulations and/or legal requirements and a new design may need to be generated to be in compliance. Further, when some products are selected, the display of product characteristics associated with the product may be regulated, which if failed to consider, may delay launch of materials and/or may result in recalls for lack of compliance. All of the additional back and forth between parties and/or potential issues with regulatory compliance may also increase costs associated with getting the product to market. In general, user development time and computing resources are lost to exaggerated exchanges in the design process, including wasted resources associated with submitting product labels that were never compliant with regulations and/or legal requirements. Further, in instances in which a user seeks to make many product labels that may include small differences between one another, the entire process (described above) may be repeated for each, which may be resource expensive and time consuming.

In some embodiments of the present disclosure, a user interface (e.g., a platform) may support the design of a product label between various stakeholders. Further, product characteristics that may be required for display may be automatically populated into a generated label, such that regulation concerns relative to the product characteristics may not cause delays relative to preparing a product. Once a product label design is complete, the product label may be submitted for review and approval to ensure associated regulations and/or legal requirements are complied with. Further, once a product label has been approved, additional materials (e.g., marketing materials) may be generated using portions of the approved product label, such that additional work associated with developing the marketing materials (e.g., ensuring compliance of the marketing materials with associated regulations and/or legal requirements) may be avoided. A product label platform may guide a user in generating a product label by verifying the generation in real time, while restricting changes to portions of the product label that may be regulated and/or required. Further, the product label platform may allow a user to generate template designs that may be reused to quickly generate additional product labels while reducing resource and time costs associated with making multiple product labels.

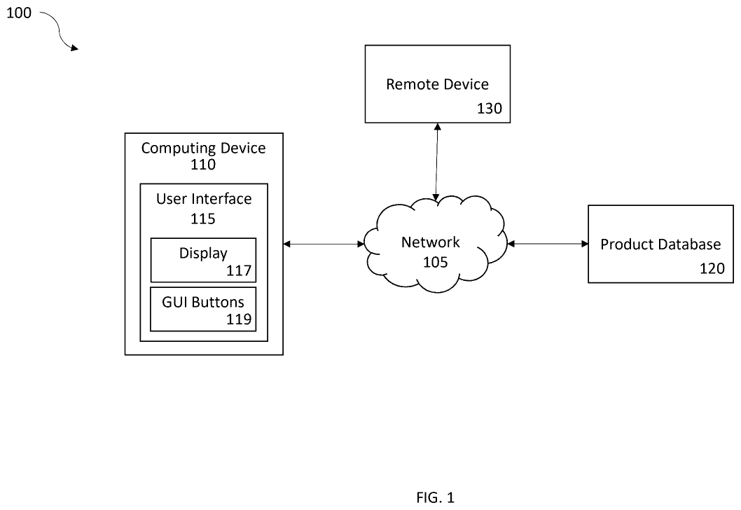

FIG. 1 illustrates a block diagram of an example system 100 for creating and modifying a product label and associated materials, in accordance with at least one embodiment of the present disclosure. The system 100 may include a network 105, a computing device 110, a product database 120, and a remote device 130. The computing device 110 may include a user interface 115. The user interface 115 may include a display 117 and graphical user interface (GUI) buttons 119.

The network 105 may support communications between at least the computing device 110, the product database 120, and/or the remote device 130. For example, in response to instructions from the computing device 110 to obtain data from the product database 120, a communication (e.g., at least the data) from the product database 120 may be transmitted to the computing device 110 via the network 105. In another example, in response to instructions from the computing device 110 to store and/or modifying data in the product database 120, a communication (e.g., the data to be stored or the data to be modified) from the computing device 110 may be transmitted to the product database 120 via the network 105. In another example, the computing device 110 may communicate a product submission to the remote device 130 via the network 105 and the remote device 130 may communicate an approval of the product submission to the computing device 110 via the network 105, as described herein.

The network 105 may include any network type that may be used to connect at least the computing device 110, the product database 120, and/or the remote device 130. For example, the network 105 may be a local area network (LAN), a wide area network (WAN), a cloud network, the internet, etc., such that the computing device 110, the product database 120, and/or the remote device 130 may be connected to one another using the network 105. Alternatively, or additionally, the network 105 may be representative of multiple network types (e.g., combinations of the previously described network types) that may be used in facilitating communications between at least the computing device 110, the product database 120, and/or the remote device 130. For example, the computing device 110 may be connected to the product database 120 using a LAN portion of the network 105 and the computing device 110 may be connected to the remote device 130 using an internet portion of the network 105.

Alternatively, or additionally, the network 105 may employ wired technologies, wireless technologies, and/or combinations thereof, operable to connect at least the computing device 110 and the product database 120. For example, the network 105 may include one or more of Ethernet, WI-FI, fiber optic, telecommunication, a network of networks, etc.

The product database 120 may be operable to store one or more products and/or product characteristics associated with the products. The product database 120 may be any storage device configured to store data, and may not be limited to a database structure. For example, the product database 120 may include tables, spreadsheets, unstructured data, key-value pairs, a file system, and/or any other electronic data storage.

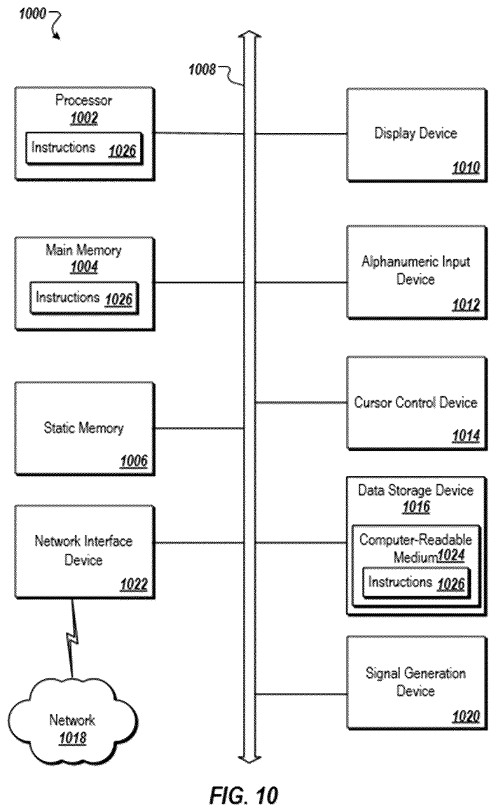

The computing device 110 may be any type of device (e.g., computing device 1000 of FIG. 10) that is configured to support a user interacting with the user interface 115 to generate, modify, and/or otherwise edit a label associated with a product, as described herein. For example, the user may use the user interface 115 to generate a label, modify portions of the label (including text, the location of the text, images, logos, etc.), and/or submit the label for review and/or approval. Alternatively, or additionally, the user may generate other materials associated with the product using the user interface 115. For example, the user may use the user interface 115 to generate marketing materials based on an approved label, where the marketing materials may be distributable various formats, such as paper flyers, social media posts (e.g., INSTAGRAM, FACEBOOK, TIKTOK, etc.), emails and/or email attachments, digital formats (e.g., PDF), 3D product renderings, etc. In the present disclosure, the term “generate” (or other forms thereof) may be used to refer to generating, modifying, or editing with respect to a label or associated marketing materials, unless specifically noted otherwise.

In these and other embodiments, the user may utilize the display 117 and the GUI buttons 119 of the user interface 115 to facilitate generation to labels and/or associated materials. For example, the display 117 may display various aspects related to generating the label and/or the associated materials, and the user may interact with portions of the label and/or the associated materials using the GUI buttons 119. In another example, the user may use the GUI buttons 119 to submit the label for review and/or approval. In general, the user may use any input device to interact with the user interface 115, which may include, but not be limited to, a mouse, a keyboard, a touch screen, an on-screen gesture, an off-screen gesture, remote devices (e.g., the user's phone connected via Bluetooth, near field communications, and the like), virtual reality inputs, augmented reality inputs, etc.

In some embodiments, the user may also begin generating marketing materials associated with the approved label, such as once the label is determined to be approved. In instances in which the user makes a modification to the approved label, the label may no longer be approved and/or the user may be limited or restricted from generating additional marketing materials until the label is again approved.

The remote device 130 may be any computing device that may be remote from the computing device 110 and may be operable to receive a generated label from the computing device 110. Remote may refer to the remote device 130 being physically separated from the computing device 110 and/or may refer to operations performed using the remote device 130 (e.g., obtain, review, and/or approve the generated label) may be remote from the operations performed using the computing device 110 (e.g., generate a label and/or marketing materials). However, in some embodiments, the remote device 130 may be the same device as the computing device 110, and may be considered remote based on different users and/or the operations performed by the different users. For example, a first user may generate a label and submit the generated label for approval using an example device and a second user may review and/or approve the generated label using the example device, where the second user may have different account permissions relative to the first user that may permit the second user to perform different operations relative to the first user (e.g., approve generated labels).

A review user or administrator may use the remote device 130 to review the generated label and/or approve the generated label. In general, the review user may perform an analysis on the generated label relative to applicable regulations and/or legal requirements that may apply to the corresponding product and/or the label associated with the product. For example, the Food and Drug Administration (FDA) may introduce regulations relative to data on the label, which may include, but not be limited to, various product characteristics, font style, font size, method of use, etc., all of which may be reviewed prior to approval of the generated label.

Alternatively, or additionally, the remote device 130 may be configured to perform an automated review and/or approval of some or all of the generated label. The remote device 130 may include a machine learning (ML) and/or an artificial intelligence (AI) component that may be trained to review and/or analyze portions of the generated label and may subsequently use the training to determine compliance of the generated label relative to the regulations and/or legal requirements. For example, the remote device 130 (e.g., the ML and/or AI component) may first be trained to determine whether required portions of a submitted label are included in the generated label and/or whether portions of the submitted label are in compliance with regulations and/or legal requirements (e.g., product characteristics, font style, font size, method of use, etc.), and the ML/AI component of the remote device 130 may use the training to make determinations relative to the generated label in view of the regulations and/or legal requirements.

In instances in which the ML/AI component of the remote device 130 determines one or more portions of the generated label fails to comply with one or more of the regulations and/or legal requirements (e.g., a non-approved label), the ML/AI component may be configured to provide a non-approved notification associated with the non-approved label to the computing device 110. The non-approved notification may provide an indication directed to the portions of the generated label that failed to comply with the regulations and/or legal requirements and/or the non-approved notification may provide one or more suggestions for revisions to the generated label to comply with the regulations and/or legal requirements.

In instances in which the ML/AI component of the remote device 130 determines the generated label is in compliance with the regulations and/or legal requirements (e.g., an approved label), the ML/AI component of the remote device 130 may provide an approved notification associated with the approved label to the computing device 110. Alternatively, or additionally, the ML/AI component of the remote device 130 may associate an approved flag with the approved label to indicate to the review user the generated label appears to be in a condition for approval and that a final review may be perform. The review user may perform a final review and may provide the approved notification to the computing device 110. Alternatively, or additionally, the review user may observe a portion of the generated label not in compliance with the regulations and/or legal requirements (e.g., a mistake by the ML/AI component) and may provide the non-approved notification to the computing device 110. In such circumstances, the review user may provide feedback and/or update the ML/AI component of the remote device 130 to correct the mistake.

In instances in which the generated label complies with the applicable regulations and/or legal requirements, the remote device 130 may communicate with the computing device 110 to indicate the generated label is approved (which may allow the user of the computing device 110 to generate marketing materials associated with the approved label). In instances in which the generated label fails to comply with one or more of the applicable regulations and/or legal requirements, the remote device 130 may communicate with the computing device 110 to indicate the generated label is not approved and/or may provide instructions associated with potential revisions to be made to the unapproved label to bring the unapproved label in compliance with the applicable regulations and/or legal requirements, such that revised label may be subsequently approved.

In an example, the user may determine a particular product for which to generate an associated label. In some embodiments, the user may perform a search of the product database 120 to determine the particular product. For example, the products in the product database 120 may be searched and/or filtered, such as by a category associated with the products, patient concerns that the products may be directed to treating, ingredients included in the products, and/or other factors associated with the products in the product database 120. Alternatively, or additionally, reviews may be associated with individual products in the product database 120, which may be viewed by the user in association with determining the particular product. The reviews may be generated and/or populated in the product database 120 from other users that may have used the particular product.

The user may select the particular product from multiple products using the user interface 115 of the computing device 110 and the user may select a template of a particular label (e.g., an initial label including multiple label sections that include at least some content that may or may not be modified by the user, as described herein) associated with the particular product to begin generating the label.

In response to selecting the particular label, product characteristics associated with the particular label may be obtained from the product database 120 via the network 105. The product characteristics may include first data and second data, where the first data may be based on regulated characteristics associated with the particular product, and the second data may be based on nonregulated characteristics that may be associated with the particular product and/or the user (e.g., the distributor of the particular product). Further, the product characteristics may be automatically populated into the particular label into respective label sections thereof by the computing device 110. For example, the computing device 110 may direct the first data associated with the regulated characteristics to a first label section of the particular label (e.g., one or more label sections that may be constrained by the applicable regulations and/or legal requirements) and the computing device 110 may direct the second data associated with the nonregulated characteristics to a second label section of the particular label (e.g., one or more label sections that may not be associated with the applicable regulations and/or legal requirements).

In general, the regulated characteristics may be regulated in view of the regulations and/or legal requirements associated with the product. Alternatively, or additionally, the regulated characteristics may be determined by a system administrator, which may restrict the modification of the regulated characteristics by the user using the computing device 110. For example, a size of a particular label associated with a particular product may not be resized by the user of the computing device 110 due to rules issued by the system administrator (e.g., the regulations and/or legal requirements may not expressly regulate a size of a label relative to a product) such that the particular label may be accurately sized relative to the particular product.

The user interface 115 may allow the user to customize and/or make modifications to portions of the particular label. The user may add or remove logos, some text, some descriptions, and/or may rearrange some portions of the label sections included on the particular label. Some of the label sections and/or the data included in the label sections (e.g., product characteristics) may be constrained by the applicable regulations and/or legal requirements. As such, in response to the user attempting to make a modification to the label sections and/or product characteristics that are regulated characteristics, the computing device 110 may restrict the modification entered by the user. Alternatively, or additionally, the computing device 110 may provide feedback to the user that the attempted modification is restricted in view of the applicable regulations and/or legal requirements associated with the product.

In response to the user attempting to make a modification to the label sections and/or product characteristics that are nonregulated characteristics, the computing device 110 may update the particular label with the modifications directed by the user. As such, the user may customize and/or rearrange portions of the particular label using the user interface 115, such as adding or editing a logo/trademark, product highlights, contact information, etc.

In some embodiments, as the user is generating the product label (e.g., in substantially real time), the computing device 110 may perform a validation of the product label, where the validation may be in view of characteristics of the product label that may be distinct from the regulations and/or legal requirements. Alternatively, or additionally, in response to the user selecting a submission button to submit the product label for review and prior to the user interface 115 displaying a user certification request, as described herein, the validation of the product label may be performed. Alternatively, or additionally, in response to the user selecting a submission button to submit the product label for review and subsequent to the user interface 115 displaying a user certification request, as described herein, the validation of the product label may be performed. The validation may include one or more constraints associated with the product label and/or the layout thereof that may be defined by an administrator (e.g., the elements considered as part of the validation may change as determined by the administrator). For example, elements considered as part of the validation may include verifying data and/or sections of the product label do not overlap one another, the text included in the product label is in a uniform direction and/or a defined direction (e.g., some text may be permitted to be rotated relative to other text), all of the displayed text is in a uniform language, the text satisfies at least a threshold size, and/or other elements associated with the product label and the design thereof.

Upon completion of generating the particular label, the user may select one of the GUI buttons 119 to submit the particular label for approval. In response to the user selecting a submit button, a prompt may be displayed on the display 117 requesting the user confirm the truth and/or accuracy of the contents of the product label (e.g., the data entered and/or modified by the user as part of the generation of the product label). In instances in which the user determines that any portion of the product label may be updated and/or may include incorrect information, the user may provide a negative response and the product label may not be submitted to the remote device 130. The user may perform additional modifications to the product label prior to again selecting the submit button.

In instances in which the user confirms the data included in the product label is true and/or accurate, and the user provides an affirmative response, the particular label may be transmitted to the remote device 130 via the network 105. The particular label may be reviewed and/or analyzed relative to the applicable regulations and/or legal requirements to ensure compliance therewith.

In instances in which any portion of the particular label fails to comply with the applicable regulations and/or legal requirements, the remote device 130 may not approve the particular label and/or may transmit instructions associated with potential corrections to the particular label directed to modifications that may place the particular label in a condition for approval.

In instances in which all portions of the particular label comply with the applicable regulations and/or legal requirements, the remote device 130 may approve the particular label and may transmit the approval of the particular label to the computing device 110.

In response to obtaining the approval of the particular label, the user may utilize the user interface 115 to purchase the particular product that may include the particular label (e.g., the approved label). Alternatively, or additionally, a remote entity (e.g., that may have a business or other association with the user) may obtain a notification that the particular product is available for purchase and may subsequently purchase the particular product including the particular label.

Alternatively, or additionally, the user may utilize the user interface 115 to generate one or more distributable materials (e.g., marketing materials) based on the approved label. For example, the product characteristics (e.g., the regulated characteristics and/or the nonregulated characteristics) included in the particular label may be populated into one or more distributable materials.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

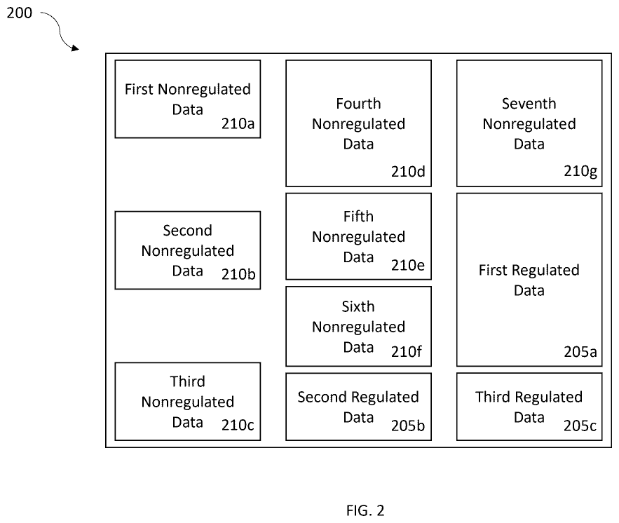

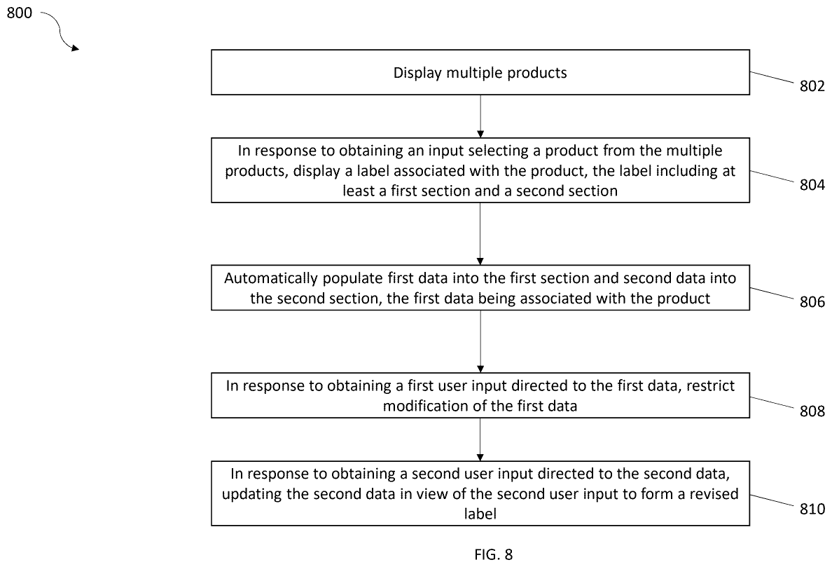

FIG. 2 illustrates a block diagram of an example product label 200 that may be generated using the system 100 of FIG. 1 and/or using method 800 of FIG. 8, in accordance with at least one embodiment of the present disclosure. The product label 200 may include a first regulated data 205a, a second regulated data 205b, and a third regulated data 205c, collectively referred to as regulated data 205, a first nonregulated data 210a, a second nonregulated data 210b, a third nonregulated data 210c, a fourth nonregulated data 210d, a fifth nonregulated data 210e, a sixth nonregulated data 210f, a seventh nonregulated data 210g, collectively referred to as nonregulated data 210.

The number of instances and/or the locations of the regulated data 205 and/or the nonregulated data 210 may be more or less than illustrated and described. For example, the product label 200 may include at least one of the regulated data 205 and at least one of the nonregulated data 210, and may include any number of instances more than one, including more or less than illustrated in the product label 200 of FIG. 2. In some examples, the product label 200 may include at least one of the regulated data 205 or the at least one of the nonregulated data 210 and not necessarily both of the regulated data 205 and nonregulated data 210.

Alternatively, or additionally, the arrangement of the regulated data 205 and the nonregulated data 210 relative to the product label 200 may vary and is displayed for illustrative purposes only. For example, the product label 200 of FIG. 2 is separated into three columns and the regulated data 205 may be located in any of the three columns. In another example, all of the regulated data 205 may be disposed in a single column of the product label 200. In some instances, some of the locations of the regulated data 205 relative to the product label 200 may be constrained by applicable regulations and/or legal requirements, which may be considered as part of the review of the product label 200 as part of an approval process, as described herein.

The regulated data 205 may include any data that may be constrained by applicable regulations and/or legal requirements. For example, for some products, the regulated data 205 may include at least a fill weight associated with the product, the ingredients included in the product, an over-the-counter (OTC) drug name included in the product, and/or contact information of an entity associated with the product. For example, the ingredients and the OTC drug name may be the first regulated data 205a, the fill weight may be the second regulated data 205b, and the contact information may be the third regulated data 205c. The regulated data 205 may include more or less items than listed and/or the elements that may be included in the regulated data 205 (e.g., the ingredients, the OTC drug name, the fill weight, etc.) may change in view of changes to the applicable regulations and/or legal requirements.

In some instances, at least a portion of the regulated data 205 may be obtained from the user in connection with the user creating a user account. For example, the user may provide contact information (e.g., a company name, an address, a phone, a website, a description, etc.), and/or may select a greeting to include on subsequent product labels (e.g., product labels that may be generated, such as the product label 200), where the greeting may be regulated by a governing organization, such as the FDA.

Alternatively, or additionally, at least a portion of the regulated data 205 may be obtained based on user input, which may or may not be related to the portion of the regulated data 205. For example, the user account may include a first greeting and the user may modify the first greeting to be a second greeting, in view of the applicable regulations and/or legal requirements associated with the greeting.

Alternatively, or additionally, at least a portion of the regulated data 205 may be obtained from product characteristics that may be stored in a product database, such as the product database 120 of FIG. 1. For example, the product database may include at least the ingredients included in a particular product, a fill weight associated with a particular product, OTC drug names associated with a particular product, and/or directions for using a particular product, which may be populated into one or more sections of the regulated data 205.

In some instances, attempts by the user to make modifications to the regulated data 205 (e.g., such as the content included therein and/or the location of the regulated data 205 relative to the product label 200) may be limited or restricted, such as by the computing device and/or software operating on the computing device. For example, in instances in which a user attempts to change one or more ingredients listed as included in the particular product, a warning/notification may alert the user that modifications to the regulated data 205 may not be permitted. In another example, in response to a user attempting to move the location of the fill weight (e.g., a portion of the regulated data 205) relative to other sections included in the product label 200, such as from a central portion of the product label 200 (e.g., a front portion of a product when the product label 200 is attached to the product) to a lateral portion of the product label 200 (e.g., a rear portion of the product when the product label 200 is attached to the product), a warning/notification may alert the user that modifications to the regulated data 205 may not be permitted. In the above examples, the user may be restricted from making changes directed to the regulated data 205, such that the regulated data 205 may remain unchanged and/or may align with the applicable regulations and/or legal requirements.

In some embodiments, some portions of the regulated data 205 may be modified, which may occur outside of the user modifying the product label 200. For example, in instances in which the entity associated with the product (e.g., the distributor of the product to which the product label 200 may be affixed) changes location and/or otherwise updates an associated contact address, the contact information included as part of the regulated data 205 may be updated. In such instances, the regulated data 205 may be constrained by data being present (e.g., current contact information for the distributor of the product to which the product label 200 may be affixed) and may not be limited to static data (e.g., the ingredients included in the product to which the product label 200 may be affixed).

The nonregulated data 210 may include any data that may not be constrained by applicable regulations and/or legal requirements. For example, for some products, the nonregulated data 210 may include a product description, product ingredient highlights, directions associated with using the product, product testing and/or recommendation highlights, a logo associated with the product and/or an entity (e.g., a person and/or company) associated with the product, a trademark associated with the product and/or an entity associated with the product, a product title, product highlights, and/or other information associated with the product and/or the entity.

For example, the product description may be the first nonregulated data 210a, the directions associated with using the product may be the second nonregulated data 210b, the product testing and/or recommendation highlights may be the third nonregulated data 210c, the logo/trademark associated with the product and/or entity may be the fourth nonregulated data 210d, the product title may be the fifth nonregulated data 210e, the product highlights may be the sixth nonregulated data 210f, and the product ingredient highlights may be the seventh nonregulated data 210g. The nonregulated data 210 may include more or less items than listed and/or the elements that may be included in the nonregulated data 210 may change in view of changes to the applicable regulations and/or legal requirements.

In some instances, at least a portion of the nonregulated data 210 may be obtained from the user in connection with the user creating a user account. For example, the user may upload or attach an image that may be used as the logo/trademark, may provide an entity description, and/or other data that may be nonregulated. In some embodiments, an image quality of an uploaded image and/or logo may be compared relative to a threshold image quality. In instances in which the uploaded image and/or logo fails to satisfy the threshold image quality, the uploaded image and/or logo may be rejected and/or a notification may be communicated to the user to upload a replacement image and/or logo.

Alternatively, or additionally, at least a portion of the nonregulated data 210 may be obtained based on user input, which may or may not be related to the portion of the nonregulated data 210. For example, the user may input the product description, the product ingredient highlights, directions associated with using the product, product testing, and/or recommendation highlights, the product title, and/or the product highlights, all of which may be included in the product label 200. Alternatively, or additionally, the user may make modifications to the nonregulated data 210, which may be unlike the regulated data 205, where the user may be unable to make modifications to the regulated data 205.

Alternatively, or additionally, at least a portion of the nonregulated data 210 may be obtained from product characteristics that may be stored in a product database, such as the product database 120 of FIG. 1. For example, the product database may include at least the product description, the product ingredient highlights, directions associated with using the product, product testing, and/or recommendation highlights, the product title, and/or the product highlights, which may be populated into one or more sections of the nonregulated data 210.

In some instances, the nonregulated data 210 may be populated automatically. Alternatively, or additionally, the nonregulated data 210 may be selected by the user from the product database to be included in the product label 200.

Further, at least some of the product characteristics, including the regulated data 205 and/or the nonregulated data 210, may be automatically populated into portions of the product label 200 in response to a particular product being selected. For example, in response to a first product being selected, first product characteristics associated with the first product (e.g., obtained from a product database) may be populated in applicable particular sections of the product label 200 and in response to a second product being selected, second product characteristics associated with the second product (e.g., obtained from the product database) may be populated in the applicable particular sections of the product label 200.

A user may use a computing device, such as the computing device 110 of FIG. 1, to generate the product label 200, which may include populating the sections of the product label 200 using the regulated data 205 and/or the nonregulated data 210. In some instances, the user may obtain a blank label associated with a particular product, may obtain the regulated data 205 from a product database (e.g., which may include automatically populating the regulated data 205 to the blank label in response to selecting the product), and/or may add, modify, and/or rearrange the regulated data 205 and/or the nonregulated data 210 to design the product label 200. For example, the blank label may be selected and at least contact information (as described herein) and/or a logo associated with the product and/or distribution thereof, may be automatically populated to the product label 200. In general, the user may use the computing device to customize the product label 200 to match any color scheme, design scheme, and/or branding, any of which may be associated with the product label 200 being generated by the user.

In some embodiments, as the user generates the product label 200, the user may be allowed to save the product label 200 during the generation process. For example, the user may be allowed to save partially-made and/or fully-made product labels. The saved labels may be stored in a database associated with the user, such as a label database or a user database. The saved labels may be used by the user as a template for generating additional product labels, to revisit a partially-made product label to finish generating the product label, and/or to revise a fully-made product label.

In some embodiments, the saved labels may be used as a template for generating additional product labels, which may facilitate a reduced product label generation process and/or reduced time to generate a product label. Either of the partially-made product label or the fully-made product label may be saved as a template product label. For example, a template product label may be selected, and the user may select/modify a color scheme, a text size, a text style, a logo and/or other branding material, etc., where the desired modifications may be constrained by regulations and/or legal requirements. In these and other embodiments, the template(s) may include automatically populated data in the labels, such as contact information, logos, and/or other identifying information, as described herein.

Alternatively, or additionally, the user may select a template label for the particular product, which may include a predetermined layout and design of the product label 200. In some embodiments, a label database may store one or more template labels that may be selected from by the user to generate the product label 200. Alternatively, or additionally, the label database may store user generated product labels, such that the user may select from a previously developed and/or submitted product label and may make modification thereto to create the product label 200.

For example, the user may generate a first product label for a particular product and may determine to generate a second product label for the particular product. The user may select the first product label, provide inputs to modify portions of the first product label (e.g., which may include modification to the nonregulated data 210 and not modification to the regulated data 205, and/or modifications to the regulated data 205 which may still conform to the applicable regulations and/or legal requirements), and may generate a second product label, which may be the product label 200.

In instances in which a first product label exists for a particular product and the user determines to generate a new product label for the particular product, a user prompt may be generated to determine from the user whether an existing product label may be modified or whether a new product label may be generated. For example, given an example product and an associated first product label, a user selecting the example product and an option (e.g., a GUI button) to design a new label may be prompted with the option to modify the first product label, and/or to generate a second product label associated with the example product.

In these and other embodiments, the user may generate the product label 200 in substantially real time and upon completion, the user may save the product label 200, which may be stored in the label database (and/or any other storage location) and/or may be associated with the user account. In such instances, the user may return to the product label 200 for future editing. In these and other embodiments, the user may design, create, modify, and/or otherwise generate the product label 200 in real time and independently of other user inputs (e.g., from one or more additional designers) prior to obtaining approval for the product label 200.

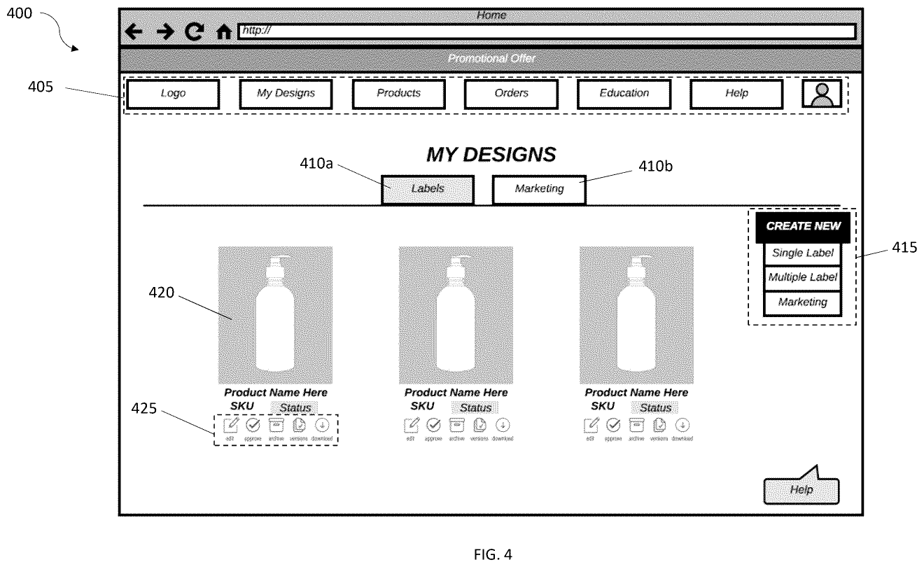

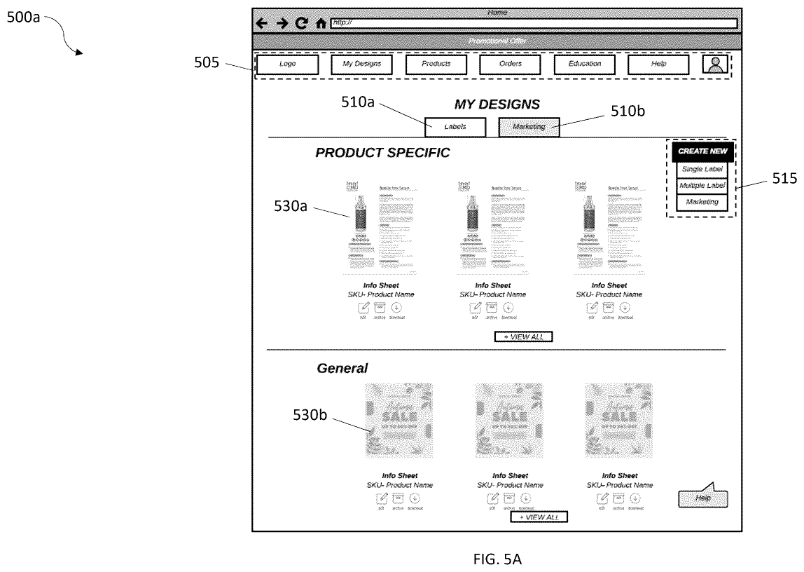

Alternatively, or additionally, the user may submit the product label 200 to a reviewing entity to obtain approval of the product label 200. The user may select a GUI button associated with the product label 200 to indicate the product label 200 is ready to be reviewed and/or approved. Examples of GUI buttons and an associated description may be seen in FIGS. 4-7 and the corresponding description herein. In some embodiments, in response to selecting the GUI button, the product label 200 may be transmitted to the reviewing entity for review and approval. Alternatively, or additionally, the user's selection of the GUI button may transmit a notification to the reviewing entity, such that the reviewing entity may obtain the product label 200 to review and/or approve the product label 200.

The reviewing entity may review the product label 200 in view of the applicable regulations and/or legal requirements associated with the product. In instances in which one or more portions of the product label 200 fail to conform to the applicable regulations and/or legal requirements, the product label 200 may not be approved and/or the reviewing entity may provide a notification to the user that the product label 200 is not approved. The notification may include one or more reasons for the non-approval and/or may provide suggested corrections that may place the product label 200 in a condition for approval. In such instances, the user may be unable to purchase the particular product with the product label 200 that is unapproved and affixed thereto (e.g., the option to purchase may be restricted to the user, until the product label 200 is approved, as described herein).

In instances in which the product label 200 is determined to be in compliance with the applicable regulations and/or legal requirements, the product label 200 may be approved and an approval notification may be transmitted to the user. The user may use the approval of the product label 200 to purchase the product with the product label 200 (e.g., the approved product label) affixed thereto.

Alternatively, or additionally, the user may generate distributable materials associated with the particular product, where the distributable materials may include the regulated data 205 and/or the nonregulated data 210 from the product label 200. The distributable materials may automatically populate with the regulated data 205 and/or the nonregulated data 210 from the product label 200. For example, contact information, logos, product names, images, and/or other elements from the product label 200 may be automatically populated in the distributable materials, such as into a template or a blank canvas, as described herein.

The distributable materials may include marketing materials and/or education materials associated with the particular product and may include some or all of the product characteristics (e.g., the regulated data 205 and/or the nonregulated data 210) included in the product label. For example, the distributable materials may include a flyer, digital advertisements (e.g., FACEBOOK ad, INSTAGRAM ad, etc.), digital content (e.g., emails, PDFs, etc.), and/or other distributable materials. Some or all of the products included in the product database (e.g., that may be an option for which the product label 200 may be generated) may include associated marketing materials and/or education materials, as described herein.

The marketing materials may include a specific marketing type that may relate to a business associated with the user and/or the product associated with the product label being designed by the user. The business marketing materials may include general content regarding the business, and may include some elements thereof automatically populated with information related to the product and/or product label, including, but not limited to, contact information, logos, business related colors and/or themes, etc. The product marketing materials may include product specific content that may include elements automatically populated based on the product label. For example, contact information, logos, product names, product descriptions, ingredients, ingredient highlights, and/or other elements from the product label may be automatically populated in the product marketing materials.

In some embodiments, the distributable materials may be based on a template design and may be in view of the product label 200. For example, the user may select a template distributable material (such as from a database, which may be the same or similar as the label database) and the user may select the product label 200 that has been approved, and a distributable material may be generated using the elements of the product label 200 and the template. Alternatively, or additionally, the user may customize the distributable material, including moving the location of some portions thereof, changing some text of portions thereof, etc., all in view of the regulated data 205 and not making changes to portions that are restricted. Alternatively, or additionally, the user may generate a new distributable material by implementing portions of the product label 200 (e.g., the approved product label) in a blank canvas and adding additional elements as desired, such as logos, promotional details associated with the particular product, availability of the particular product, and so forth. The user may be able to make various other customizations to the distributable materials, including selecting fonts, colors, images, clipart, etc., all of which may be selected from a template and/or user generated. In these and other embodiments, the user may save the distributable material (such as in the label database, or another application storage location), such that the distributable material may be edited at a later time, downloaded in a digital format (e.g., PDF), and/or printed/distributed for use, such as for use as a marketing material.

In some embodiments, the distributable material may include an interactable object that may provide a link to the particular product (e.g., that includes the product label 200 that is approved). For example, the distributable material may include a bar code, a QR code, a hyperlink, a tag, and/or any other linked object that may be scanned and/or selected (e.g., via user input, such as a mouse click) that may cause a device of the user to open and/or display the particular product. For example, a user may scan a QR code that may open a digital storefront associated with the particular product for display, such that the particular product (e.g., including the product label 200) may be purchased from the digital storefront.

Modifications, additions, or omissions may be made to the product label 200 without departing from the scope of the present disclosure. For example, the designations of different elements in the manner described is meant to help explain concepts described herein and is not limiting. Further, the product label 200 may include any number of other elements or may be implemented within other systems or contexts than those described. For example, any of the elements of FIG. 2 may be divided into additional or combined into fewer components, and/or may be located in different portions of the product label 200.

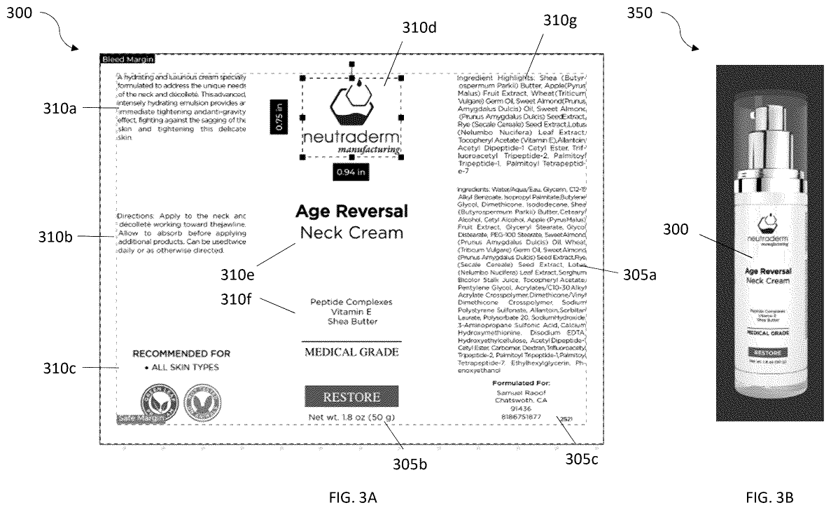

FIG. 3A illustrates an example embodiment of a product label 300 of FIG. 2 and FIG. 3B illustrates the product label of FIG. 3A applied to an example product 350, in accordance with at least one embodiment of the present disclosure. The product label 300 may be customizable using a GUI. FIG. 3A may be illustrative of how the GUI may present the product label 300 and customizability thereof. The product label 300 may include a first regulated data 305a, a second regulated data 305b, and a third regulated data 305c, collectively referred to as regulated data 305, a first nonregulated data 310a, a second nonregulated data 310b, a third nonregulated data 310c, a fourth nonregulated data 310d, a fifth nonregulated data 310e, a sixth nonregulated data 310f, a seventh nonregulated data 310g, collectively referred to as nonregulated data 310. The product label 300 may include the same or similar elements as the product label 200 of FIG. 2, where the reference numbers may be similar between the two figures. For example, the first regulated data 305a may be the same or similar as the first regulated data 205a of FIG. 2, and so forth. The product 350 may be an example of the product label 300 affixed to the product 350.

As described relative to the product label 200 of FIG. 2, some or all of the elements of the product label 300 may be rearranged relative to one another using the GUI. For example, the location of the seventh nonregulated data 310g and the first nonregulated data 310a may be swapped. In some embodiments, some elements of the product label 300 may be unable to be rearranged, such as due to applicable regulations and/or legal requirements. For example, the second regulated data 305b (e.g., which may be a fill weight of the product) may be constrained by FDA regulations to be on a central (e.g., front) portion of the product label 300.

In general, the product label 300 illustrates various text and/or images that may be included in various sections of the product label 300, as described herein. The product label 300 may be representative of a product label that may still be in a design phase, and/or may be a product label that has been approved for use in view of the applicable regulations and/or legal requirements. Further, the product 350 of FIG. 3B may illustrate to the user how the product label 300 may be displayed when affixed to the product 350. Alternatively, or additionally, the product 350 may be used as a display for consumer purchase. For example, in instances in which a consumer enters a digital storefront, the product 350 may be displayed as an indication for purchase.

FIG. 4 illustrates an example user interface 400 which may be used to generate a product label and associated materials, in accordance with at least one embodiment of the present disclosure. In some embodiments, the user interface 400 may include page navigation buttons 405, label navigation button 410a, marketing navigation button 410b, generation buttons 415, images 420, and label management buttons 425. In the present disclosure, the described buttons may refer to GUI buttons that may be selected, pressed, clicked, or otherwise interacted with via a user input device.

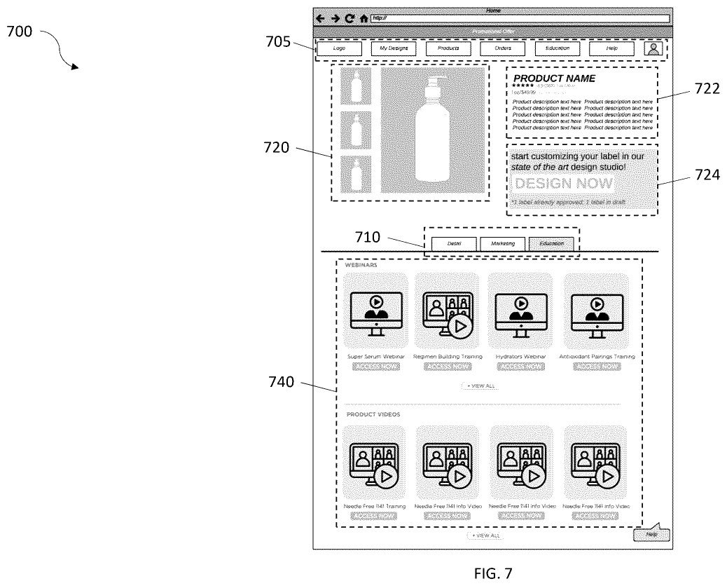

The page navigation buttons 405 may be selected by the user to navigate through pages (e.g., webpages) that may be associated with generating a product label and/or associated materials, as described herein. The page navigation buttons 405 may include, but not be limited to, a logo page button, a user design page button, a products page button, an orders page button, an education page button, a help page button, and/or an account silhouette button. In some embodiments, one or more of the pages may be navigated to using more than one method. For example, the education page may be navigated to by selecting the education page button from the page navigation buttons 405 and/or may be navigated to by selecting another education button, such as relative to a selected product, such as illustrated and described relative to FIG. 7. In some embodiments, the page navigation buttons 405 may be displayed on all associated webpages. For example, as the user selects one or more of the page navigation buttons 405 to branch to a different page, the page navigation buttons 405 may be displayed on each of the different pages.

The logo page (e.g., displayed by selecting the logos page button) may display logos that are associated with the user account and that may have been uploaded and/or stored by the system (e.g., the computing device 110 of FIG. 1). The user may add logos, remove logos, and/or modify stored logos, where the logos may be used in generating product labels, such as on the designs page, as described herein.

The designs page (e.g., displayed by selecting the designs page button, and which may be the page displayed in FIG. 4) may display user generated product labels and/or associated products. In instances in which no product labels have been designed and/or no products are selected, the designs page may be substantially blank and/or may not display the images 420 and/or the label management buttons 425. Alternatively, or additionally, in instances in which more product labels and/or products are generated and/or available to the user, scrolling options may be available to the user such that the user may view/interact with multiple product labels and/or associated products.

In some embodiments, the designs page may include the generation buttons 415 that may be associated with generating a new product label, multiple product labels, and/or marketing materials associated with the products labels and/or associated products. The multiple product labels may include multiple product labels associated with a single product, and/or multiple product labels associated with multiple products. Alternatively, or additionally, the designs page may include a “Save as Template” button, that may be selected to save a product label design as a template to be used to generate additional product labels. The Save as Template button may cause the user interface 400 to store and/or direct the storage of the product label that is being generated.

The products page (e.g., displayed by selecting the products page button) may display one or more products that have approved product labels and/or are otherwise ready for sale to others. Alternatively, or additionally, the products page may display multiple products that may be selected from and for which a product label may be designed by the user. In some embodiments, the user may generate one or more kits of approved product labels and/or approved products, such that when selected, the products included in the kits may automatically generate a 3D image associated with the approved products and/or product labels.

The orders page (e.g., displayed by selecting the orders page button) may provide the user with information related to orders of products that include the product labels generated by the user. For example, subsequent to generating the product label and obtaining an approval of the product label, the user may have the option to purchase the product provided on the orders page. Alternatively, or additionally, the orders page may provide a summary of previous orders and/or may provide interactions associated with the previous orders (such as cancel, reorder, etc.).

In some embodiments, the orders page may provide the user with additional information and/or options regarding the purchase and/or handling of the product subsequent to the purchase thereof. For example, the user may select an option to shrink wrap the products as part of the purchase of the products. In some embodiments, selecting the shrink wrap option may enable the user to purchase any amount of the product. For example, not selecting the shrink wrap option may limit purchases of the product to large quantities (e.g., large enough to substantially fill a shipping palette of the product), and selecting the shrink wrap option may enable the user to purchase any amount of the product, including smaller quantities (e.g., relative to the large quantities, which may include any amount less than substantially filling a shipping palette of the product). Alternatively, or additionally, the orders page may provide estimates on shipping fees associated with shipping the product and based on the location to which the product is to be shipped (e.g., the user's shipping address and/or an address designated by the user to which the products may be shipped).

The orders page may provide the user with pricing details, discounts, and or selectable payment options. For example, the orders page may display a product quantity that if ordered may provide a bulk discount (e.g., the orders page may indicate how many additional products to purchase to obtain a bulk discount). In another example, promotional discounts may be provided such as purchase a first number of products and receive a second number of products free and the orders page may indicate the number of products remaining to purchase to obtain the promotional discount. In some embodiments, the orders page may facilitate payment options with the user. Some payment options may be available to some users but not all users and the payment options may be based at least on a user payment history. For example, a first user that is new or behind on payments may have some payment options limited while a second user that is established and/or up to date on outstanding payments may have all payment options available. Some payment options may include credit card, net-15, net-30, net-60, 25% balance down prior to shipment, balance net-15, balance net-30, and/or other payment options. In these and other embodiments, any of the discounts, pricing details, and/or other purchasing options may be displayed on the orders page, such as in a shopping cart displayed thereon.

The education page (e.g., displayed by selecting the education page button) may provide the user with materials associated with the products such that the user may obtain information related to the products. For example, the education page may include ingredient information, directions for use, testing standards, and the like, all of which may be individually associated with the products, such as the products displayed on the products page. In some embodiments, the education page may include links (e.g., hyperlinks) to external websites that may include more or supplemental information associated with the products.

The help page (e.g., displayed by selecting the help page button) may include resources associated with the products, the product labels, use of the website, and/or other aspects included in the present disclosure. The help page may include a frequently asked questions portion that may include one or more answers to common issues that may be encountered as part of product label design, associated marketing, and/or purchase of products related thereto. Alternatively, or additionally, the help page may include one or more channels to contact an external user/device (such as the remote device 130 of FIG. 1) to obtain answers to potential questions or issues that may arise as part of the product label development described herein.

In some embodiments, selecting the help page button may initiate a chat function. The chat function may enable the user to communicate with a reviewing entity to further the development of a product label, which may include performing a quality check on a design of an in-progress product label (e.g., an unapproved label). In such instances, the chat function may support image, text, and/or status updates between the user and the reviewing entity. For example, the user may open the chat function and may communicate a logo for review. In response, the reviewing entity may communicate an edited logo, which may provide instructions to the user to modify the submitted logo to be in a better position for approval.

In some embodiments, the chat function may facilitate a status update between the user and the reviewing entity regarding approval of a product label and/or aspects of the product label. For example, subsequent to the user submitting a particular product label for approval, the user may initiate the chat function and request a status update associated with an approval process of the particular product label. In response, the reviewing entity may provide a status update associated with the particular label, which may include any present rejections, potential time frame for approval and/or response, any outstanding questions and/or requests, and so forth. In these and other embodiments, the chat function may provide live time communications between the user and the reviewing entity, such that status updates, questions associated with the development of a product label, and/or other questions between the user and the reviewing entity may be discussed in substantially live time.

In some instances, the chat function may automatically populate with selectable buttons individually associated with the product labels designed by a user. For example, in instances in which a user has a first product label design and a second product label design, a first button (associated with the first product label design) and a second button (associated with the second product label design) may be automatically populated in the chat function. The user may select one of the automatically populated buttons to provide an initial indication to a support (e.g., a technical support user) as to the product and/or product label with which the user may be requesting help. The number of selectable buttons may increase or decrease as the user may create or remove product label designs.

The account page (e.g., displayed by selecting the account silhouette button) may allow the user to update account information, which may include the contact information that may be included on the product label. For example, in instances in which first contact information associated with the user (and/or previously included on a product label) has changed (e.g., the entity moved locations), the user may use the account page to update the contact information, which may then be updated on the product labels.

The label navigation button 410a and the marketing navigation button 410b may be used to view and/or interact with the label design page or the marketing design page, respectively. For example, the user may select the my designs page of the page navigation buttons 405 and the user may select the label navigation button 410a to generate a product label, and/or the user may select the marketing navigation button 410b to generate a marketing material associated with the product and/or product label.

The images 420 may display to the user products including product labels that may be designed, marketed, and/or offered for sale. In some embodiments, the images 420 may include a product name, which may be modified by the user. The product name may be the same or similar as a product name that may be displayed on the associated product label. Alternatively, or additionally, the images 420 may include a stock-keeping unit (SKU) associated with the product, that may be used by the user to maintain an inventory of the product. In some instances, the user may add, remove, and/or modify the SKU associated with any of the products associated with the user (e.g., viewable on the designs page).

The images 420 may include an associated status indicator that may display a status of the product label. For example, in instances in which the product label is not complete and/or not approved, the status indicator may display not approved (or similar indication). In another example, the status indicator may update to approved (or similar indication) in response to the product label being approved, as described herein.

The label management buttons 425 may be utilized by the user to interact with and manage the product labels displayed in the user interface 400. The label management buttons 425 may include one or more of an edit button, an approve button, an archive button, a version button, and/or a download button. More or less buttons than those described and/or illustrated may be included in the user interface 400.

The edit button may be selected to edit the associated product label (e.g., the product label associated with the edit button selected). The approve button may be selected to send the associated product label to a reviewing entity for review and approval. The archive button may be used to remove a product label from a product and/or remove the product label from view of the user while viewing the designs page. The version button may allow the user to see different versions of the product label and/or see observe changes to the product label as edits may be made. The download button may be selected by the user to download an image of the product label and/or the product including the product label.

In these and other embodiments, the label management buttons 425 may be operable to cause a change to the status (e.g., approved, pending, draft, etc.) and/or the status indicator associated with a particular product displayed in the user interface 400. For example, in instances in which a user selects the edit button associated with a particular product that includes an approved product label, the status and/or the status indicator associated with the particular product may automatically update from approved to draft (or another non-approved status). In another example, in instances in which a user completes a draft of a product label and selects the approve button, the status indicator may automatically update from draft to pending (e.g., where the product label may remain pending until approved by a reviewing entity, as described herein).

Modifications, additions, or omissions may be made to the user interface 400 without departing from the scope of the present disclosure. For example, the designations of different elements in the manner described is meant to help explain concepts described herein and is not limiting. Further, the user interface 400 may include any number of other elements or may be implemented within other systems or contexts than those described. For example, any of the elements of FIG. 4 may be divided into additional or combined into fewer components, and/or may be located in different portions of the user interface 400.

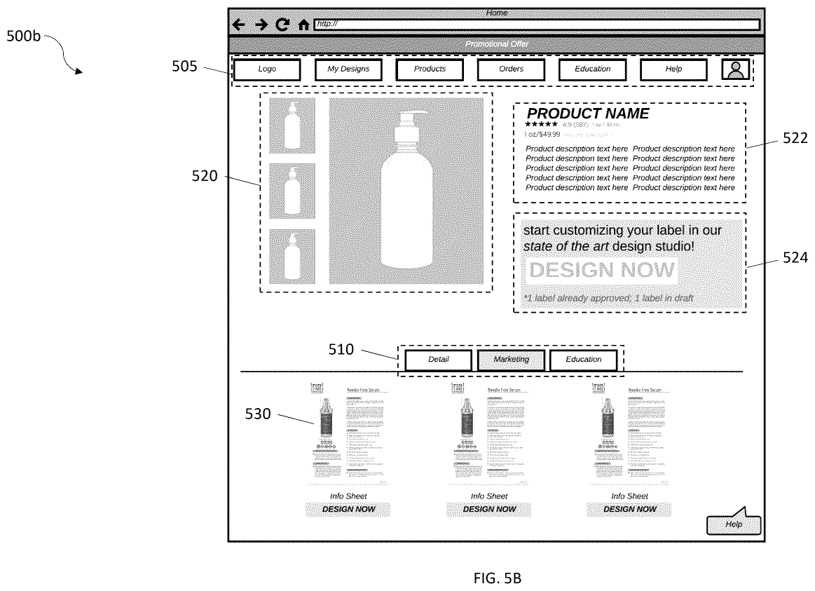

FIGS. 5A and 5B illustrate example user interface 500a and example user interface 500b, respectively, which may be used to generate a product label and associated materials, in accordance with at least one embodiment of the present disclosure. The user interface 500a may include page navigation buttons 505, label navigation button 510a, marketing navigation button 510b, generation buttons 515, product marketing materials 530a, and general marketing materials 530b, referred to collectively as marketing materials 530. The user interface 500b may include page navigation buttons 505, navigation buttons 510, images 520, product description 522, design button 524, and marketing materials 530.

In general, the user interface 500a and the user interface 500b may include one or more buttons and/or elements that may be the same or similar as the user interface 400 of FIG. 4. For example, the page navigation buttons 505, the navigation buttons 510, the generation buttons 515, and the images 520 may be the same or similar as the page navigation buttons 405, the label navigation button 410a and the marketing navigation button 410b, the generation buttons 415, and the images 420 of FIG. 4, respectively. Alternatively, or additionally, the user interface 500a and the user interface 500b may illustrate the marketing material design aspect associated with the product label design described herein. In some embodiments, the user interface 500a and/or the user interface 500b may not be selectable unless a product label is approved and associated with the user account.

The product marketing materials 530a may display a product that may include a product label that has been approved. A user may select a product displayed as the product marketing materials 530a and may generate marketing materials associated therewith. Alternatively, or additionally, the user may select from the general marketing materials 530b to design a marketing material that may be implemented with products and/or product labels (e.g., approved product labels) generated by the user.

The product description 522 may include a product name and/or product characteristics associated with the product. In some embodiments, the product description 522 may be imported from one or more portions of the product label that may have been generated. For example, in response to a user selecting a product (e.g., such as from a product listed in the product marketing materials 530a), the product may be displayed as the image 520, the product description associated with the product may be populated into the product description 522, and the option to design and/or modify a product label associated with the product may be allowed via the design button 524. In some embodiments, the image 520 may be a 3D rendering or preview of the product (e.g., with or without the product label). Alternatively, or additionally, the image 520 may be an interactable, 3D rendering of the product that may be manipulated by the user viewing the image 520. For example, the user may rotate, turn, flip, and/or otherwise manipulate the image 520 (which may be a 3D rendering, as described) to see different portions and/or views of the product (e.g., a front view, a side view, etc.).

In some embodiments, the design button 524 may provide an indication of product labels associated with the product that may be generated and/or approved. For example, the design button 524 associated with an example product may indicate that a first product label that is approved exists and a second product label that is a draft exists. Selecting the design button 524 may generate a prompt to the user to edit existing product labels and/or to generate a new product label.

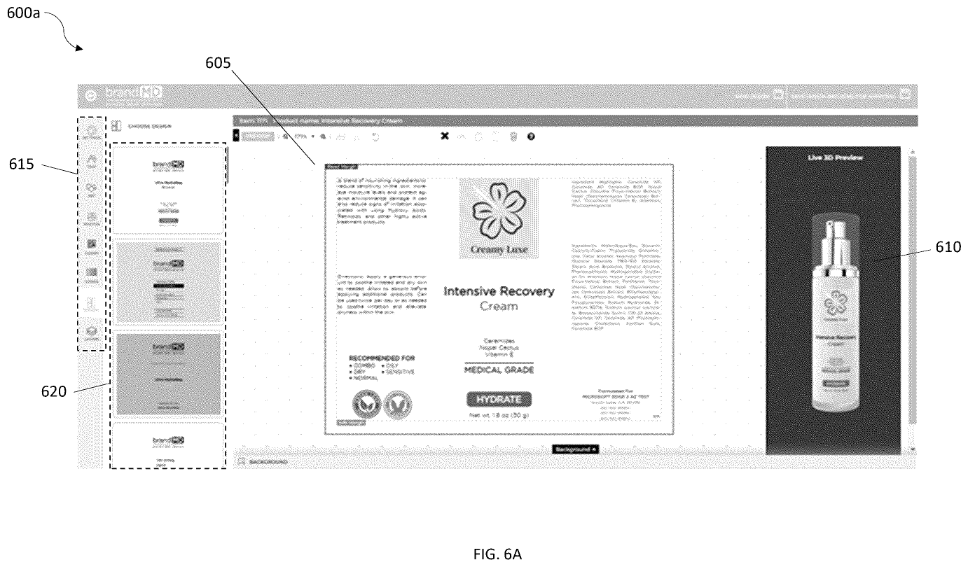

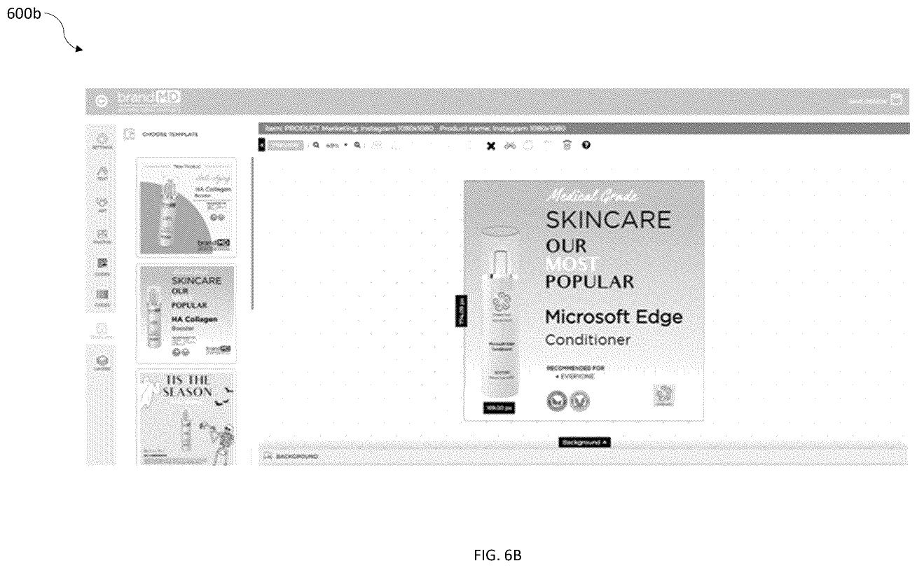

In some embodiments, selecting the design button 524 may open a design studio page where the user may use a design studio to design, modify, and/or otherwise generate a product label. Example design studio user interfaces are illustrated in FIGS. 6A and 6B.

FIGS. 6A and 6B illustrate example user interface 600a and example user interface 600b, respectively, which may be used to design a product label and associated materials, in accordance with at least one embodiment of the present disclosure. The user interface 600a may include a canvas 605, a rendering 610, editing buttons 615, and template designs 620. The user interface 600b may be substantially the same as the user interface 600a, and the user interface 600b may illustrate a user interface for designing distributable materials associated with a product and/or a product label.

The user interface 600a may be referred to as a design studio 600a. The design studio 600a may provide an interface for the user to perform some or all of the label generation and/or design as described herein. For example, in response to the user selecting a product, the design studio 600a may automatically populate portions of the product label in the canvas 605, including at least the contact information, the logo, and/or the regulated data, such as FDA required information.

Using the design studio 600a, the user may select a template product label from the template designs 620 to use as a product label and/or the user may select a template product label and make modifications thereto in the canvas 605, so as to generate a new product label. The user may use the canvas 605 to rearrange and/or customize the layout of the elements in the product label, as described herein. In some embodiments, within the design studio 600a, the user may save a designed product label as a master template and the master template may be selectable as an option from the template designs 620 during subsequent product label designs (e.g., the master template may be added to the template designs 620).

Alternatively, or additionally, the design studio 600a may facilitate customization of the product label, where the user may rearrange and/or modify various elements of the product label, as described herein. For example, the user may select a text button of the editing buttons 615 to adjust the fonts to be used for text on the product label, where the fonts may be preapproved and/or compliant with any applicable regulations and/or legal requirements. In another example, the user may select a colors button of the editing buttons 615 to adjust one or more colors for portions of the product label, where the colors may be included in a predetermined palette and/or may be selected using custom color gradients. The design studio 600a may provide images, icons, and/or other clipart that the user may include as part of generating the product label, which may be accessed using the editing buttons 615, such as an art button of the editing buttons 615. Alternatively, or additionally, selecting an art button of the editing buttons 615 may facilitate the user uploading images to be included in the product label. The design studio 600a may provide an indication (e.g., a visual indicator) as to whether the uploaded images satisfy a threshold image quality, and in instances in which the uploaded image fails to satisfy the threshold image quality, the design studio 600a may prompt the user to upload a new image to replace the existing image.

In these and other embodiments, the design studio 600a may include a display of the in-development product label (e.g., the product label being designed in the design studio 600a) as the rendering 610. The rendering 610 may be adjacent to the canvas 605 and may display a current status of the product label in design in the design studio 600a.

In some embodiments the rendering 610 may be 3D, such as affixed to the product to which the product label is being designed. Alternatively, or additionally, the rendering 610 may be 2D, which may be as a distributable material, such as a paper flyer or a digital advertisement.

The design studio 600a may facilitate barcode and/or a quick-response (QR) code generation and/or placement on the product label. For example, the user may select a barcode button and/or a QR code button of the editing button 615 to generate a particular barcode and/or a particular QR code, respectively, that may individually provide a link to educational materials associated with the product. Subsequently, the user may use the design studio 600a to include the particular barcode and/or the particular QR code to the product label, such as placing the particular barcode and/or the particular QR code on the product label within the canvas 605.

The design studio 600a may provide functionality for the user to save the product label. The save of the product label may be the rendering 610 of the product label, which may be a 3D rendering of the product label in the design studio 600a attached to the associated product. Alternatively, or additionally, the user may direct the design studio 600a to save the product label as a static PDF, which may be downloaded (e.g., to a personal computing device associated with the user) and/or printed out (e.g., to be used as a marketing material or other distributable material, as described herein). In some embodiments, the user may direct a label type to be associated with the product label, where the label type may direct a printing type that may be used during the process of printing the product label. For example, the user may select one of clear printing, silk screen printing, and/or white printing as the label type for the product label.

FIG. 7 illustrates an example user interface 700 which may be used to generate a product label and associated materials, in accordance with at least one embodiment of the present disclosure. The user interface 700 may include page navigation buttons 705, navigation buttons 710, images 720, product description 722, design button 724, and informational materials 740.

In general, the user interface 700 may include one or more buttons and/or elements that may be the same or similar as the user interface 500b of FIG. 5. For example, the page navigation buttons 705, the navigation buttons 710, the images 720, the product description 722, and the design button 724 may be the same or similar as the page navigation buttons 505, the navigation buttons 510, the images 520, the product description 522, and the design button 524.

The informational materials 740 may include videos, text, and/or other materials that may be associated with a selected product. For example, a selected product may be displayed in the images 720 (e.g., with an associated product description in the product description 722), and the informational materials 740 may be populated with text and/or videos associated with the selected product, such as how to use, benefits of the selected product, how the selected product is made, and so forth. In general, the informational materials 740 may be populated with any materials configured to disseminate information associated with a selected product.

FIG. 8 illustrates a flowchart of an example method 800 of generating a product label, in accordance with at least one embodiment of the present disclosure. The method 800 may be performed by processing logic that may include hardware (circuitry, dedicated logic, etc.), software (such as is run on a general purpose computer system or a dedicated machine), or a combination of both, which processing logic may be included in any computer system or device such as the computing device 110 of FIG. 1 and/or the computing device 1000 of FIG. 10.

At block 802, multiple products may be displayed.

At block 804, in response to obtaining an input selecting a product from the multiple products, a label associated with the product may be displayed. The label may include at least a first section and a second section. In some embodiments, the label may be obtained from a predetermined template that may be associated with the product. Alternatively, or additionally, the label may be obtained from a second database that may be associated with the user. The second database may be populated with one or more user submitted product labels.

At block 806, first data may be automatically populated into the first section. Alternatively, or additionally, second data may be automatically populated into the second section. The first data may be associated with the product and/or may be stored in a product database. Alternatively, or additionally, additional first data associated with the multiple products may be stored in the product database. The second data may include nonregulated data that may be associated with the product.

The first data may include regulated data that may be associated with the product. The regulated data may be constrained by one or more regulations associated with the product. In some embodiments, the first data may include one or more of a fill weight associated with the product, one or more ingredients included in the product, an over-the-counter drug name included in the product, one or more directions associated with a use of the product, and contact information of an entity associated with the product.

At block 808, in response to obtaining a first user input directed to modifying the first data, modification of the first data may be restricted.

At block 810, in response to obtaining a second user input directed to the second data, the second data may be updated in view of the second user input to generate a revised label.

Modifications, additions, or omissions may be made to the method 800 without departing from the scope of the present disclosure. For example, in response to obtaining a submission input (e.g., from the user), a user certification request may be displayed. Alternatively, or additionally, in response to obtaining an affirmative response to the user certification request, the revised label may be submitted for review and/or approval. In another example, in response to obtaining an approved label based on the revised label, one or more distributable materials may be displayed based on the approved label. Further, in response to a user interaction with the one or more distributable materials, a digital storefront may be displayed to display the product and/or offer the product for sale.

In some embodiments, the label may be designed by the user in real time. For example, the label may be designed by the user using inputs from the user and without external inputs and/or design from an external user (e.g., such as an illustrator, designer, etc.). In some embodiments, in response to a third user input, the first section and the second section on the label may be rearranged. For example, the user may determine to rearrange portions of the first data and the second data into different sections of the label, relative to one another.

In another example, the designations of different elements in the manner described is meant to help explain concepts described herein and is not limiting. Further, the method 800 may include any number of other elements or may be implemented within other systems or contexts than those described.

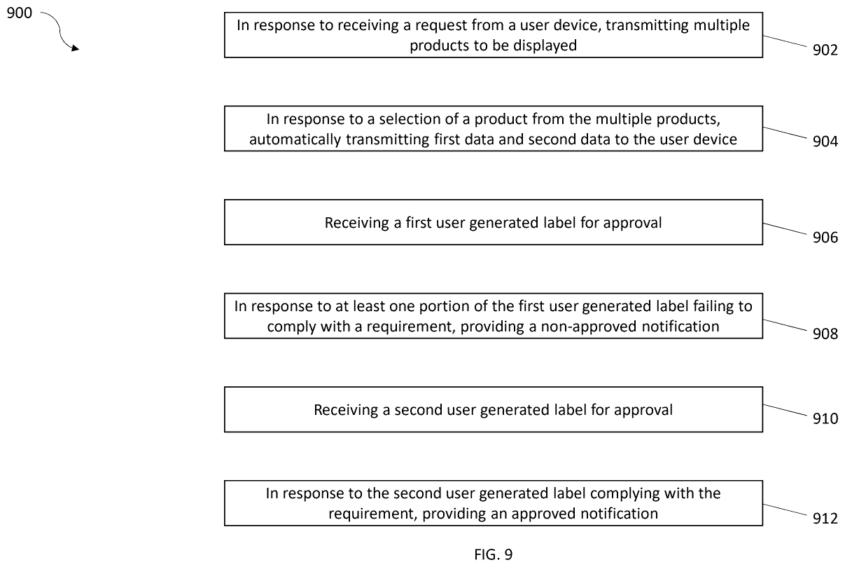

FIG. 9 illustrates a flowchart of an example method 900 of generating a product label, in accordance with at least one embodiment of the present disclosure. The method 900 may be performed by processing logic that may include hardware (circuitry, dedicated logic, etc.), software (such as is run on a general purpose computer system or a dedicated machine), or a combination of both, which processing logic may be included in any computer system or device such as the computing device 110 of FIG. 1 and/or the computing device 1000 of FIG. 10.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 902, in response to receiving a request from a user device, transmitting multiple products may be transmitted. In some embodiments, the multiple products may be displayed on the user device.

At block 904, in response to a selection of a product from the multiple products, first data and second data may be automatically transmitting to the user device. In some embodiments, the first data may be associated with the product and/or may be stored in a product database. Alternatively, or additionally, the second data may be associated with a user of the user device and/or may be stored in a second database.

At block 906, a first user generated label may be received for approval.

At block 908, in response to at least one portion of the first user generated label failing to comply with a requirement, a non-approved notification associated with the first user generated label may be provided to the user device. In some embodiments, the requirement may include regulations and/or legal requirements associated with the product. The non-approved notification may include at least one reason for non-approval. Alternatively, or additionally, the non-approved notification may include at least one suggestion to place the first user generated label in a condition for approval.

At block 910, a second user generated label may be received for approval.

At block 912, in response to the second user generated label complying with the requirement; an approved notification associated with the second user generated label may be provided to the user device.

Modifications, additions, or omissions may be made to the method 900 without departing from the scope of the present disclosure. For example, the designations of different elements in the manner described is meant to help explain concepts described herein and is not limiting. Further, the method 900 may include any number of other elements or may be implemented within other systems or contexts than those described.

FIG. 10 illustrates an example computing device 1000 within which a set of instructions, for causing the machine to perform any one or more of the methods discussed herein, may be executed. For example, the computing device 110 and/or the remote device 130 may be implemented as computing device 1000. The computing device 1000 may include a mobile phone, a smart phone, a wearable device, a headset, a virtual reality device, an augmented reality device, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 1000 includes a processing device (e.g., a processor) 1002, a main memory 1004 (e.g., read-only memory (ROM), flash memory, dynamic random access memory (DRAM) such as synchronous DRAM (SDRAM)), a static memory 1006 (e.g., flash memory, static random access memory (SRAM)) and a data storage device 1016, which communicate with each other via a bus 1008.

The processing device 1002 represents one or more general-purpose processing devices such as a microprocessor, central processing unit, or the like. More particularly, the processing device 1002 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 may also include one or more special-purpose processing devices such as an application specific integrated circuit (ASIC), a field programmable gate array (FPGA), a digital signal processor (DSP), network processor, or the like. The processing device 1002 is configured to execute instructions 1026 for performing the operations and steps discussed herein.

The computing device 1000 may further include a network interface device 1022 which may communicate with a network 1018. The computing device 1000 also may include a display device 1010 (e.g., a liquid crystal display (LCD) or a cathode ray tube (CRT)), an alphanumeric input device 1012 (e.g., a keyboard), a cursor control device 1014 (e.g., a mouse) and a signal generation device 1020 (e.g., a speaker). In at least one implementation, the display device 1010, the alphanumeric input device 1012, and the cursor control device 1014 may be combined into a single component or device (e.g., an LCD touch screen).

The data storage device 1016 may include a computer-readable storage medium 1024 on which is stored one or more sets of instructions 1026 embodying any one or more of the methods or functions described herein. The instructions 1026 may also reside, completely or at least partially, within the main memory 1004 and/or within the processing device 1002 during execution thereof by the computing device 1000, the main memory 1004 and the processing device 1002 also constituting computer-readable media. The instructions may further be transmitted or received over a network 1018 via the network interface device 1022.

While the computer-readable storage medium 1024 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A method comprising:
displaying a plurality of products;
in response to obtaining an input selecting a product from the plurality of products, displaying a label associated with the product, the label including at least a first section and a second section;
automatically populating first data into the first section and second data into the second section, the first data being associated with the product;
in response to obtaining a first user input directed to the first data, restricting modification of the first data; and
in response to obtaining a second user input directed to the second data, updating the second data in view of the second user input to generate a revised label.

2. The method of claim 1, wherein the first data associated with the product and additional first data individually associated with the plurality of products is stored in a product database.

3. The method of claim 1, further comprising:
in response to obtaining a submission input, displaying a user certification request; and
in response to obtaining an affirmative response to the user certification request, submitting the revised label for review and approval.

4. The method of claim 3, wherein in response to obtaining an approved label based on the revised label, further comprising displaying one or more distributable materials based on the approved label.

5. The method of claim 4, wherein in response to a user interaction with the one or more distributable materials, displaying a digital storefront to display the product and offer the product for sale.

6. The method of claim 1, wherein the first data includes regulated data associated with the product, where the regulated data is constrained by one or more regulations associated with the product.

7. The method of claim 6, wherein the first data comprises one or more of a fill weight associated with the product, one or more ingredients included in the product, an over-the-counter drug name included in the product, one or more directions associated with a use of the product, and contact information of an entity associated with the product.

8. The method of claim 1, wherein the second data includes nonregulated data associated with the product.

9. The method of claim 1, wherein in response to obtaining a third user input, rearranging the first section and the second section on the label.

10. A method, comprising:
in response to receiving a request from a user device, transmitting a plurality of products to be displayed;
in response to a selection of a product from the plurality of products, automatically transmitting first data and second data to the user device;
receiving a first user generated label for approval;
in response to at least one portion of the first user generated label failing to comply with a requirement, transmitting a non-approved notification associated with the first user generated label to the user device;
receiving a second user generated label for approval; and
in response to the second user generated label complying with the requirement; transmitting an approved notification associated with the second user generated label to the user device.

11. The method of claim 10, wherein the first data is associated with the product and is stored in a product database, and the second data is associated with a user of the user device and is stored in a second database.

12. The method of claim 10, wherein in response to a user interaction with one or more distributable materials, causing a digital storefront to display the product and offer the product for sale.

13. The method of claim 10, wherein the requirement comprises regulations and legal requirements associated with the product.

14. The method of claim 10, wherein the non-approved notification includes at least one reason for non-approval and at least one suggestion to place the first user generated label in a condition for approval.

15. A user design platform comprising:
a product database comprising product characteristics associated with a product, the product characteristics including first data and second data; and
a user interface to display at least the product and the product characteristics, wherein:
in response to a first user input directed to the first data, restricting modification of the first data; and
in response to a second user input directed to the second data, updating the second data in view of the second user input to generate a label for the product.

16. The user design platform of claim 15, wherein the user interface further comprises a submission button to submit the label for review and approval.

17. The user design platform of claim 16, wherein the user interface displays one or more distributable materials based on an approved label, the approved label received in response to the label being submitted and approved.

18. The user design platform of claim 15, wherein the first data includes regulated data associated with the product and the second data includes nonregulated data associated with the product, where the regulated data is constrained by one or more regulations associated with the product.

19. The user design platform of claim 15, wherein an initial label is obtained from a predetermined template associated with the product and the label includes revisions to the initial label in view of the second user input.

20. The user design platform of claim 15, wherein in response to a third user input, rearranging the first data and the second data on the label.
